(19) United States
(12) Patent Application Publication
(10) Pub. No.: US 2025/0038834 A1
(43) Pub. Date: Jan. 30, 2025

(54) METHOD AND APPARATUS FOR HANDLING NTN STORE AND FORWARD CONFIGURATION IN A WIRELESS COMMUNICATION SYSTEM

(71) Applicant: ASUS Technology Licensing Inc., Taipei City (TW)

(72) Inventor: Meng-Hui Ou, Taipei City (TW)

(21) Appl. No.: 18/783,099

(22) Filed: Jul. 24, 2024

Related U.S. Application Data
(60) Provisional application No. 63/529,270, filed on Jul. 27, 2023.
(60) Provisional application No. 63/534,740, filed on Aug. 25, 2023.

(51) Int. Cl. H04B 7/185

(52) U.S. Cl. CPC H04B 7/18513

(57) ABSTRACT

Methods, systems, and apparatuses are provided for handling Non-Terrestrial Network (NTN) store and forward (S&F) configurations in a wireless communication system, wherein a method of a User Equipment (UE) comprises being provided with an indication or a configuration about traffic type for an S&F operation from a network, and determining whether to use the S&P operation based on the indication or the configuration

### CROSS-REFERENCE TO RELATED APPLICATIONS

The present Application claims priority to and the benefit of U.S. Provisional Patent Application Ser. No. 63/529,270, filed Jul. 27, 2023, and U.S. Provisional Patent Application No. 63/534,740, filed Aug. 25, 2023; with each of the referenced applications and disclosures fully incorporated herein by reference.

### FIELD

This disclosure generally relates to wireless communication networks and, more particularly, to a method and apparatus for handling a Non-Terrestrial Network (NTN) store and forward (S&F) configuration in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling Non-Terrestrial Network (NTN) store and forward (S&F) configurations in a wireless communication system. In various embodiments, A User Equipment (UE) can transmit data based on S&F operation efficiently. The satellite network (NW) could obtain the required S&F related configuration from a ground NW and could use S&F operation properly.

In various embodiments, a method of a UE comprises being provided with an indication or a configuration about traffic type for an S&F operation from a network, and determining whether to use the S&F operation based on the indication or the configuration.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.1-1: Non-terrestrial network typical scenario based on transparent payload, from 3GPP TR 38.821 V16.0.0.

FIG. 6 is a reproduction of FIG. 4.1-2: Non-terrestrial network typical scenario based on regenerative payload, from 3GPP TR 38.821 V16.0.0.

FIG. 7 is a reproduction of FIG. 5.2.1-1: Regenerative satellite without ISL, gNB processed payload, from 3GPP TR 38.821 V16.0.0.

FIG. 8 is a reproduction of FIG. 5.2.1-2: Regenerative satellite with ISL, gNB processed payload, from 3GPP TR 38.821 V16.0.0.

FIG. 9 is a reproduction of FIG. 5.2.2-1: NG-RAN with a regenerative satellite based on gNB-DU, from 3GPP TR 38.821 V16.0.0.

FIG. 10 is a reproduction of FIG. A-1: Illustration of “normal/default operation” and “S&F operation” modes in a 5G system with satellite access, from 3GPP TR 22.865 V2.0.0.

FIG. 11 is a reproduction of FIG. 5.4.3-1: Animal tracking in the remote areas, from 3GPP TR 22.865 V2.0.0.

FIG. 12 is a reproduction of a figure of Potential call flow for intermittent feeder link, from 3GPP RWS-230178.

FIG. 13 is a reproduction of FIG. 4.2.3-1: Non-Roaming 5G System Architecture, from 3GPP TS 23.501 V18.1.0.

FIG. 14 is an example diagram showing an NTN network, in accordance with embodiments of the present invention.

FIG. 15 is an example diagram showing that after receiving the configuration of an S&F operation, the satellite NW may start the S&F operation (and/or provide S&F service to a UE) when there is no feeder link with the ground NW, in accordance with embodiments of the present invention.

FIG. 16 is an example diagram showing that a satellite NW may initiate a procedure and then after the procedure is completed (successfully), the satellite NW may start an S&F operation, in accordance with embodiments of the present invention.

FIG. 17 is an example diagram showing that a ground NW may initiate a procedure and then after the procedure is completed (successfully), the ground NW may transmit the data/signaling/message to the satellite NW, in accordance with embodiments of the present invention.

FIG. 18 is a flow diagram of a method of a UE comprising receiving a configuration or an indication related to an S&F operation, and determining whether to use the S&F operation based on the configuration or the indication, in accordance with embodiments of the present invention.

FIG. 19 is a flow diagram of a method of a first network node comprising transmitting a first signaling to a second network node, and receiving a second signaling from the second network node, in accordance with embodiments of the present invention.

FIG. 20 is a flow diagram of a method of a second network node comprising receiving a first signaling from a first network node, wherein the first signaling is used to indicate or request an S&F operation, and transmitting a second signaling to the first network node, in accordance with embodiments of the present invention.

FIG. 21 is a flow diagram of a method of a UE comprising being provided with an indication or a configuration about traffic type for an S&F operation from a network, and determining whether to use the S&F operation based on the indication or the configuration, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TR 38.821 V16.0.0, “Solutions for NR to support non-terrestrial networks (NTN)”; [2] 3GPP TR 22.865 V2.0.0, “Study on satellite access Phase 3 (Release 19)”; [3] 3GPP TS 23.501 V18.1.0, “System architecture for the 5G system (5GS)”; and [4] 3GPP RWS-230178, “NR and IoT NTN”. The standards and documents listed above are hereby expressly and fully incorporated herein by reference in their entirety.

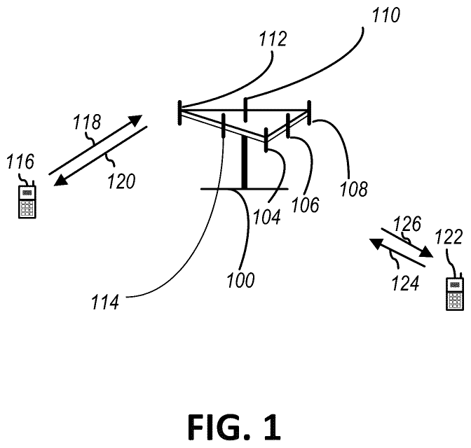

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

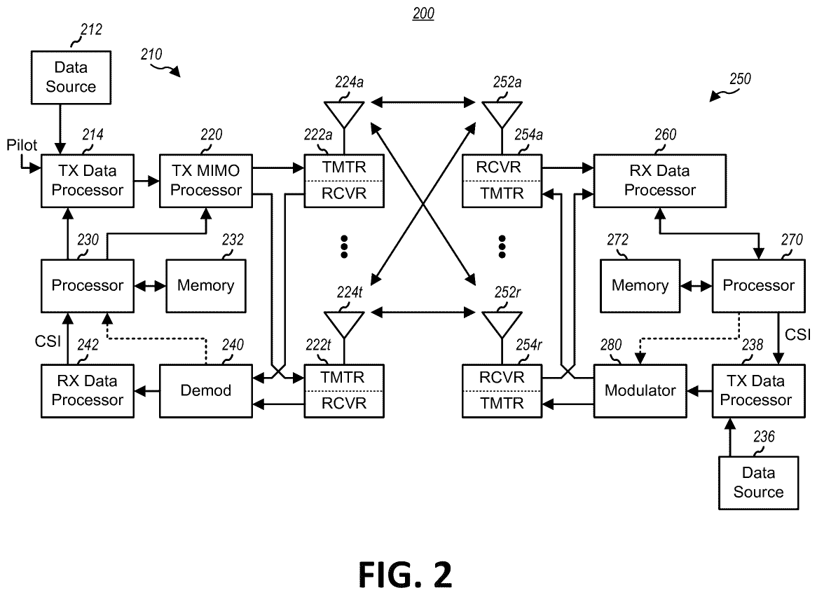

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

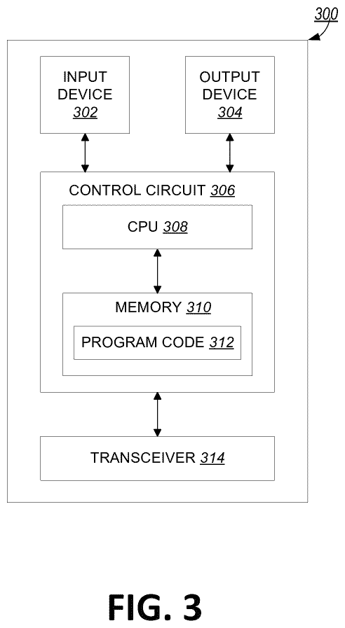

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

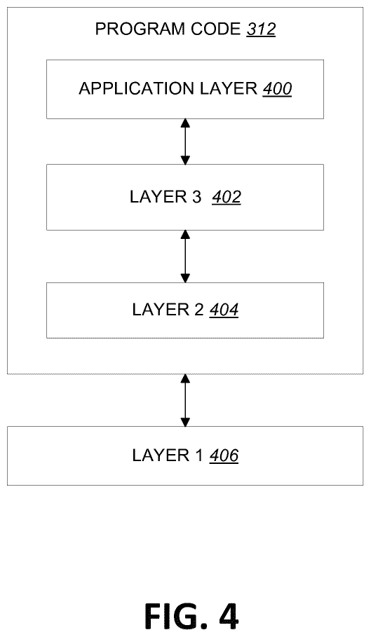

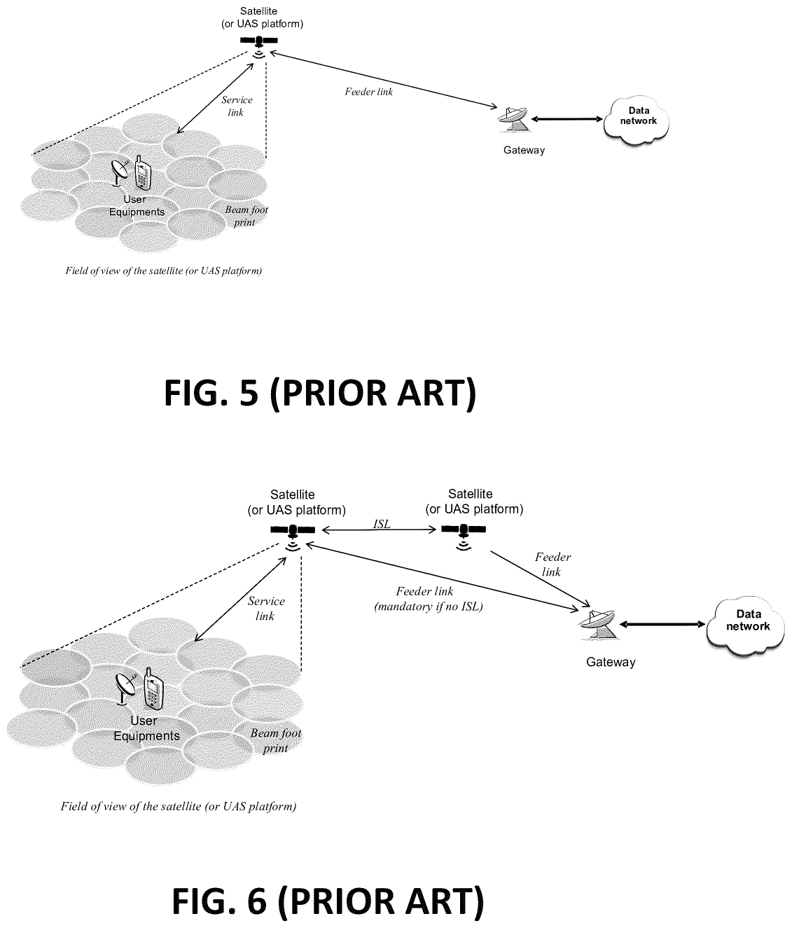

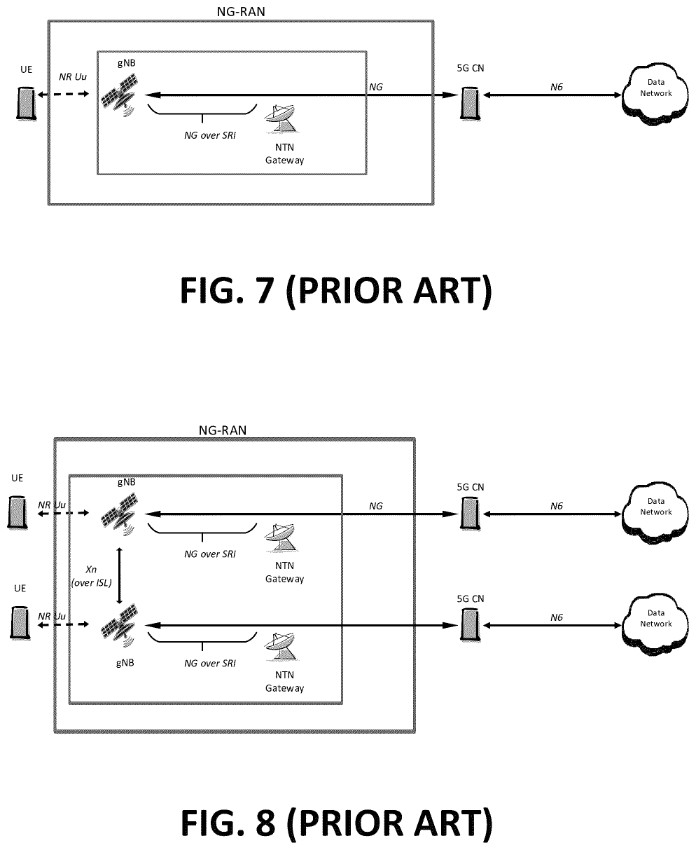

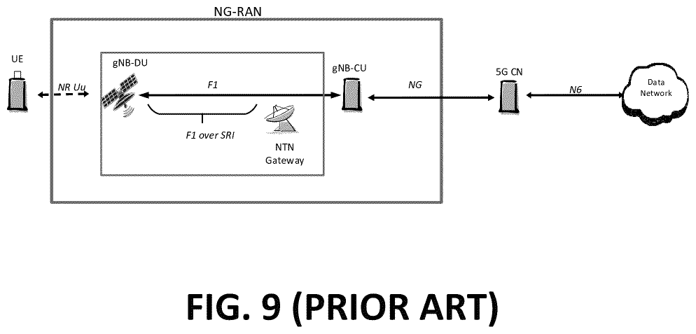

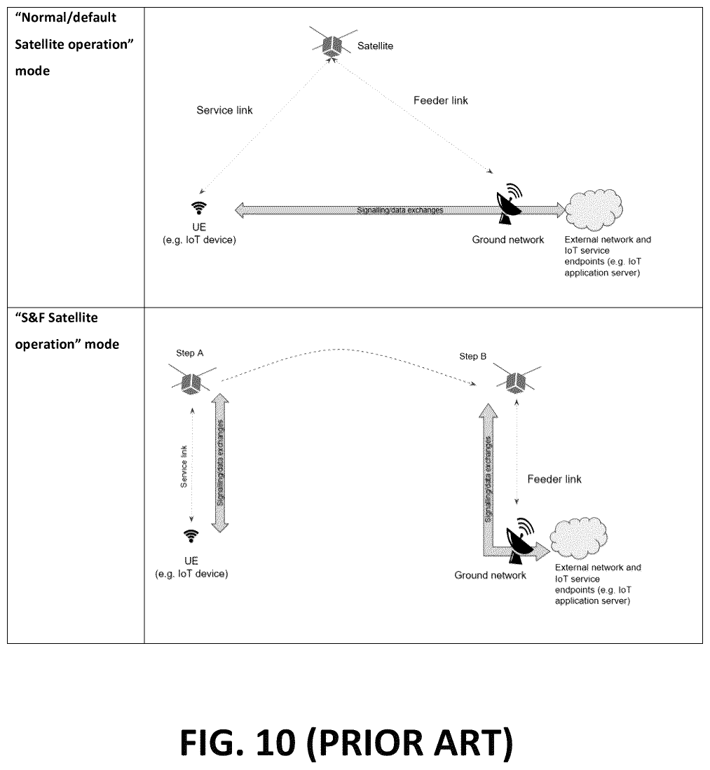

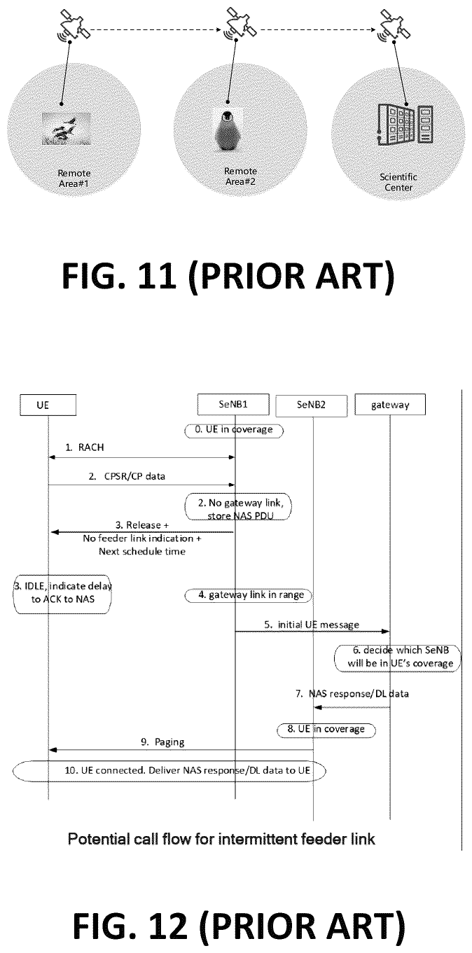

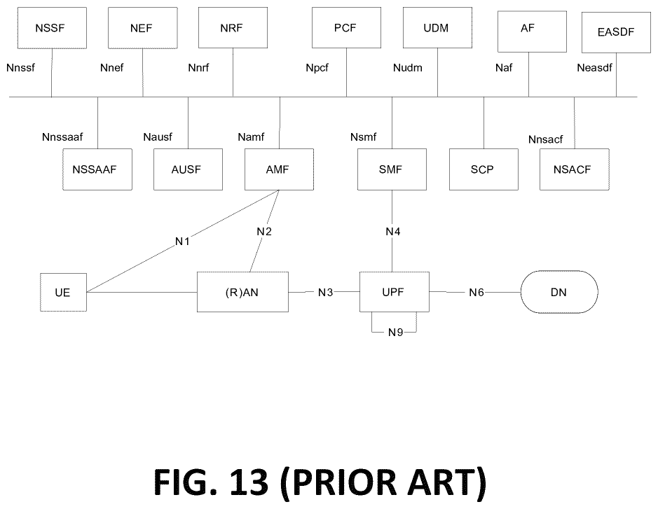

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In 3GPP TR 38.821 ([1] 3GPP TR 38.821 V16.0.0), study on NR NTN (non-terrestrial networks) is introduced. NTN is defined as networks, or segments of networks, using an airborne or space-borne vehicle to embark a transmission equipment relay node or base station. More descriptions are also specified in [1] 3GPP TR 38.821 V16.0.0.

A Non-terrestrial network (NTN) is a network such as Next Generation (NG)-Radio Access Network (RAN) consisting of Next Generation Node Bs (gNBs), which provide non-terrestrial access to User Equipment(s) (UE(s)) by means of an NTN payload embarked on an airborne or space-borne NTN vehicle and an NTN Gateway. The UE may link to, camp on and/or connect to the NTN network that involves airborne/spaceborne for transmission. The NTN may comprise various platforms, including Low Earth Orbit (LEO) satellite, Medium Earth Orbit (MEO) satellite, Highly Elliptical Orbit (HEO) satellite, Geostationary Earth Orbit (GEO) satellite, Geostationary Synchronous Orbit (GSO) satellite, Non-Geostationary Synchronous Orbit (NGSO) satellite, and/or High Altitude Platform Station (HAPS). A LEO satellite could have an earth-fixed beam (e.g., the beam is temporarily fixed on a location during a time period) or an earth-moving beam (e.g., the beam is continuously moving along with the satellite). A LEO satellite could serve/provide earth moving cells (e.g., with an earth-fixed beam) and/or (quasi-)earth fixed cells (e.g., with an earth-moving beam). The NTN could offer a wide-area coverage and provide a NW access in the scenario when terrestrial networks (TNs) are unfeasible (e.g., desert, polar area, and/or on an airplane). More details regarding different NTN platforms could be found in TR 38.821 ([1] 3GPP TR 38.821 V16.0.0).

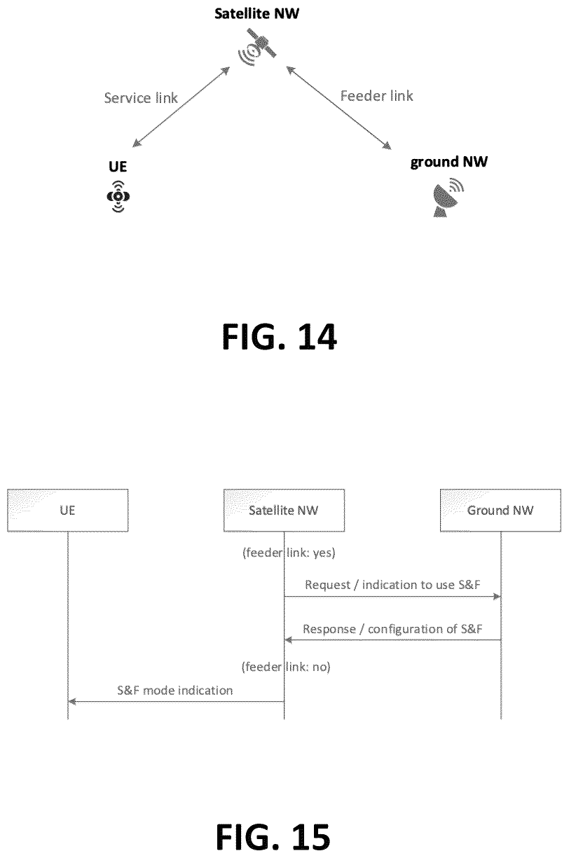

Store & forward (S&F) operation is an operation mode of satellite-access providing some level of service (in storing and forwarding the data) when satellite connectivity is intermittently/temporarily unavailable, e.g., to provide communication service for UEs under satellite coverage without a simultaneous active feeder link connection to the ground segment. The network supporting S&F operation may be based on an architecture of regenerative payload. At least some network node (or network segment) is located in a satellite. The network node(s) (or network segment(s)) on a satellite may be (or comprise) NG-RAN, Evolved Node B (eNB), gNB, gNB-Distributed Unit (DU), Core Network (CN) node, User Plane Function (UPF), a portion of UPF, Access and Mobility Management Function (AMF), a portion of AMF, Session Management Function (SMF), a portion of SMF, Mobility Management Entity (MME), a portion of MME, Serving 30 Gateway (SGW), a portion of SGW, Packet Data Network (PDN) gateway (PGW), a portion of PGW, Home Subscriber Server (HSS), a portion of HSS, and/or the combination of the above. The rest of the network node(s) (or network segment(s)) in the system (e.g., 5G system) could be located on the ground. The network node(s) (or network segment(s)) on the ground may be NG-RAN, eNB, gNB, gNB-DU, CN node, UPF, a portion of UPF, AMF, a portion of AMF, SMF, a portion of SMF, MME, a portion of MME, SGW, a portion of SGW, PGW, a portion of PGW, HSS, a portion of HSS, the rest of CN node(s) that are not located on a 35 satellite, and/or the combination of the above. For illustration, the network node(s) (or network segment(s)) located in a satellite may be denoted as a NW on a satellite (or a satellite NW). For illustration, the network node(s) (or network segment(s)) located on the ground may be denoted as a NW on the ground (or a ground NW). For example, the satellite NW may include NG-RAN and the ground NW may include 5GC. For example, the satellite NW may include an eNB and MME (or part of MME), and the ground NW may include the other part of MME. For example, the satellite NW may include a gNB and UPF (or part of UPF), and the ground NW may include 5G CN (excluding the part of UPF located in the satellite). The link/connection/interface between the satellite NW and the ground NW may be referred as a feeder link. The link/connection/interface between the satellite NW and the UE may be referred as a service link. An example is shown in FIG. 14.

In [4] RWS-230178, a potential call flow for S&F is illustrated. Based on the call flow, the UE performs communication (e.g., transmits Non-Access Stratum (NAS) Protocol Data Unit (PDU) such as CP data) with the NW as normal (e.g., like legacy NTN, as if no S&F operation is used), and if the NW detects that there is no gateway link, it stores NAS PDU and transmits a “no feeder link indication”+“next schedule time” in a release message (as in step 3 of the flow). Upon receiving the indication, the UE enters IDLE mode and indicates delay to Acknowledgement (ACK) to NAS. Based on the call flow, the UE cannot know that the NW is using an S&F operation until receiving the indication in the release message. However, there may be several drawbacks with the S&F operation based on the call flow.

Firstly, maybe not every type of traffic (e.g., User Plane (UP) data, Control Plane (CP) data, CP signaling, Short Message Service (SMS)) is suitable for the S&F operation. For example, delay-sensitive data may not tolerate the delay of the S&F operation. In such a case, data transmitted to the NW may be discarded in the satellite. Transmitting the data and/or signaling to the satellite NW without feeder link is a waste of radio resources.

Secondly, the UE is not aware that the NW is using the S&F operation, e.g., the data and/or the signaling transmitted to the satellite NW will be stored until a feeder link is available at a later time, when transmitting data and/or signaling to the NW. Whether the NW is under the S&F mode or not may impact the UE on e.g., how the UE transmits the data and/or the signaling.

To solve the issue, the NW (e.g., satellite NW) could provide/provision/configure/update (at least) an indication and/or a configuration/parameter related to S&F (e.g., before the UE transmits data to the NW), which may be included in a signaling. The UE could determine whether and/or how to transmit data and/or signaling (e.g., using the S&F operation) based on (at least) the indication and/or the configuration/parameter. For example, if the UE detects that the NW is using an S&F operation (e.g., the feeder link is not available currently), the UE may use the S&F operation, and/or not generate (or transmit) data (or signaling) that is not suitable for the S&F operation (e.g., the QoS requirement such as a delay requirement cannot be fulfilled) to the NW.

If the UE receives (the signaling with) the indication and/or the configuration/parameter related to S&F (e.g., the indication and/or the configuration/parameter is present and/or enabled), the UE may consider that the NW (e.g., the satellite NW) is using an S&F operation, under S&F mode, the feeder link of the NW is not available, and/or the NW is not able to forward data/signaling to the ground NW. The UE may use (or enable) the S&F operation (in response).

If the UE does not receive the signaling, does not receive the indication and/or the configuration/parameter related to S&F, and/or the indication and/or the configuration is absent and/or disabled, the UE may consider that the NW (e.g., the satellite NW) is not using an S&F operation, not under S&F mode, the feeder link of the NW is available, and/or the NW is able to forward data/signaling to the ground NW. The UE may not use (or disable) the S&F operation (in response).

The indication and/or the configuration/parameter related to S&F may be provided (by the NW, e.g., the satellite NW) (to the UE) in a broadcast signaling, e.g., system information, paging. The UE may acquire the broadcast signaling upon (or in response to) camping/selecting/reselecting a cell, handover (to the cell), serving cell change (to the cell), and/or informed by the NW (e.g., notification of system information change).

The indication and/or the configuration/parameter related to S&F may be provided (by the NW, e.g., the satellite NW) (to the UE) in a dedicated signaling. The dedicated signaling may be a NAS message or a Radio Resource Control (RRC) message. The dedicated signaling may be a reconfiguration message (e.g., an RRC reconfiguration message). The dedicated signaling may be a NAS notification message. The dedicated signaling may be a paging message.

The dedicated signaling may be a response message to a UE request. The dedicated signaling may be a NAS message or an RRC message. The UE request may be a request message to establish an RRC connection, NAS connection, and/or a PDU session. The UE request may be a service request.

The indication and/or the configuration/parameter related to S&F may (or may not) be provided during a procedure (e.g., between the UE and the NW). The procedure may be initiated by the UE. The procedure may be initiated by the NW. The procedure may (or may not) be a registration procedure. The registration procedure may (or may not) be for initial registration. The registration procedure may (or may not) be for a mobility registration update. The registration procedure may (or may not) be for a periodic registration update. The procedure may (or may not) be a service request procedure. The procedure may (or may not) be a notification procedure. The procedure may (or may not) be a PDU session establishment procedure. The procedure may (or may not) be a PDU session modification procedure. The procedure may be an (initial) attach procedure.

The indication and/or the configuration/parameter related to S&F may be provided (by the NW, e.g., satellite NW) (to the UE) by pre-configured or provisioned in the UE.

NW may determine whether to provide the indication and/or the configuration/parameter related to S&F based on (at least) whether the feeder link of the NW is available or not. For example, if the NW receives a UE request from the UE (e.g., to establish/modify an RRC connection, a NAS connection, and/or a PDU session), the NW may determine (whether) to accept (or reject) the UE request based on (at least) whether the feeder link of the NW is available, and/or whether the UE request (e.g., the corresponding connection, PDU session, and/or Quality of Service (QOS) flow) can be operated in an S&F operation (e.g., whether the corresponding QoS requirement can be fulfilled). If yes, the NW may accept the UE request. The NW may provide the indication and/or the configuration related to S&F in the accept message. If no, the NW may reject the UE request. The NW may provide a reject cause in the reject message to the UE. The reject cause may be related to the S&F operation, e.g., the feeder link is not available.

The configuration (and/or the indication/parameter) related to S&F may be associated (or specific) to an object. The object may be (or comprise) a UE, a cell, a connection (e.g., RRC connection, NAS connection), a (type of) traffic, a PDU session, and/or a QoS flow. The NW may indicate (or configure) which object that the configuration (and/or the indication/parameter) is associated to. The NW may provide (at least) one configuration (and/or the indication/parameter) to (at least) one object.

The configuration (and/or the indication/parameter) related to S&F may be/comprise/be used for/indicate one or more of the following:

### S&F Mode Indication

The indication may (at least) indicate whether the S&F operation is enabled or not (e.g., in the cell, for the UE, to the NW). The indication may (at least) indicate whether a feeder link of the NW is available or not. The indication may (at least) indicate whether the UE is allowed to use the S&F operation (e.g., in the cell, to the NW).

The UE may determine (whether) to use S&F operation based on (at least) the indication. For example, if the UE receives the indication, the UE may consider the S&F operation is enabled (and/or activated). If the UE does not receive the indication, the UE may consider the S&F operation is not enabled (and/or activated). If the UE receives the indication, the UE may be allowed to use the S&F operation. If the UE does not receive the indication, the UE may not be allowed to use the S&F operation. The UE may be of a specific UE type. The UE type is illustrated below.

### UE Type

The configuration may (at least) indicate what (type of) UE is allowed to use the S&F operation. The configuration may (at least) indicate what (type of) UE is allowed to perform transmission and/or reception to the NW (e.g., using the S&F operation). The transmission and/or reception may be (UP) data and/or (CP) signaling.

The UE type (e.g., a first type) may be based on (or identified by/represented by/specific to) UE capability, UE mobility, QoS characteristic of the UE, UE status. The UE type may be (or comprise) (at least) a (e)Machine Type Communication (MTC) UE, a Narrowband Internet of Things (NB-IoT) UE, a RedCap (reduced capability) UE, a UE supporting NR, a UE supporting 5GC, a UE supporting NTN, a UE supporting regenerative payload, a UE with a Global Navigation Satellite System (GNSS), and/or a UE supporting an S&F operation. The UE type may be (or comprise) (at least) a stationary UE, a low mobility UE, and/or a UE within a limited area. The UE type may be (or comprise) (at least) a UE with a low QoS requirement, and/or a UE without Ultra-Reliable Low Latency Communications (URLLC).

The configuration may (also) be pre-configured. For example, a first type of UE is allowed to use the S&F operation if the UE receives the S&F mode indication. For example, a first type of UE is (always) allowed to use the S&F operation.

The UE may determine (whether) to use the S&F operation based on (at least) the configuration. For example, if the UE receives the configuration and/or the UE belongs to a UE type in the configuration (or pre-configuration), the UE may consider the S&F operation is enabled (and/or activated, and/or allowed). If the UE receives the configuration and/or the UE does not belong to a UE type in the configuration (or pre-configuration), the UE may consider the S&F operation is not enabled (and/or activated, and/or allowed). If the UE does not receive the configuration, the UE may consider the S&F operation is not enabled (and/or activated, and/or allowed).

### Traffic Type

The configuration may (at least) indicate what (type of) traffic or service is allowed to use the S&F operation. The configuration may (at least) indicate what (type of) traffic or service is allowed to be transmitted to the NW (e.g., using S&F operation). The (type of) traffic may include (UP) data and/or (CP) signaling. The (type of) traffic may include SMS (short message service). The traffic may be an Access Stratum (AS) level and/or a NAS level. The configuration may (also) be pre-configured. The configuration may be based on a QoS requirement of the traffic (or the traffic type).

The traffic (or the traffic type) may be based on (or identified by/represented by/specific to) a QoS flow, a PDU session, a radio bearer (Signaling Radio Bearer (SRB) and/or Data Radio Bearer (DRB)), a Radio Link Control (RLC) bearer, and/or a logical channel.

An explicit configuration may be used for some traffic (or traffic type), and an implicit configuration (or pre-configuration) may be used for some (other) traffic (or traffic type). For example, whether a first traffic (or traffic type) is allowed to use the S&F operation may be based on the configuration. Whether a second traffic (or traffic type) is allowed to use the S&F operation may be based on a pre-configuration (e.g., allowed, not allowed, without configuration).

The UE may determine (whether) to use the S&F operation (e.g., for a specific traffic/service or traffic type/service type) based on (at least) the configuration. For example, if the UE receives the configuration and/or the traffic/service of the UE is included in the configuration (or pre-configuration), the UE may consider the S&F operation is (or is not) enabled (and/or activated, and/or allowed), e.g., for the traffic/service. If the UE receives the configuration and/or the traffic/service of the UE is not included in the configuration (or pre-configuration), the UE may consider the S&F operation is not (or is) enabled (and/or activated, and/or allowed), e.g., for the traffic/service. If the UE receives the configuration and/or the traffic/service of the UE could fulfill the condition/limitation/restriction/requirement of the configuration (or pre-configuration), the UE may consider the S&F operation is enabled (and/or activated, and/or allowed), e.g., for the traffic/service. If the UE receives the configuration and/or the traffic/service of the UE cannot fulfill the condition/limitation/restriction/requirement of the configuration (or pre-configuration), the UE may consider the S&F operation is not (or is) enabled (and/or activated, and/or allowed), e.g., for the traffic/service. If the UE does not receive the configuration, the UE may consider the S&F operation is (or is not) enabled (and/or activated, and/or allowed), e.g., for every (or all) traffic/service of the UE.

If the UE considers the S&F operation is allowed/enabled/activated for a traffic/service, the UE may perform transmission (and/or reception) of the traffic/service (e.g., using the S&F operation), initiate a procedure to (or for) performing transmission (and/or reception) of the traffic/service (e.g., using the S&F operation), and/or to request permission/establishment/resource for the traffic/service (e.g., using the S&F operation). If the UE considers the S&F operation is not allowed/enabled/activated for a traffic/service, the UE may not perform transmission (and/or reception) of the traffic/service (e.g., using the S&F operation), not initiate a procedure to (or for) performing transmission (and/or reception) of the traffic/service (e.g., using the S&F operation), and/or not request permission/establishment/resource for the traffic/service (e.g., using the S&F operation). The procedure may be a registration procedure (e.g., for initial and/or mobility update), attach, a service request procedure, a PDU session establishment (or modification) procedure.

### QoS Parameter

The parameter may be used by the UE (e.g., based on at least the parameter) to determine (at least) whether QoS requirement of a UE request (e.g., for a service, connection, PDU session, and/or QoS flow) can be fulfilled. The parameter may be used by the UE (e.g., based on at least the parameter) to (at least) determine whether to initiate a UE request (e.g., for a service, connection, PDU session, and/or QoS flow).

The parameter may be (at least) based on (or identified by/represented by/specific to) a UE, a connection, a service, a PDU session, and/or a QoS flow. The configuration may (at least) indicate what type of UE, connection, service, PDU session, and/or QoS flow is associated to the parameter. The parameter may be (at least) based on (or identified by/represented by/specific to) a radio bearer (SRB and/or DRB), an RLC bearer, and/or a logical channel. The configuration may (at least) indicate what type of radio bearer, RLC bearer, and/or logical channel is associated to the parameter.

The parameter may be (or comprise) (at least) a QoS Flow Identifier (QFI), a 5G QoS identifier (5QI), an Allocation and Retention Priority (ARP), a resource type, a priority level, a packet error rate, an averaging window, a delay budget (e.g., packet delay budget), and/or a data volume (maximum data burst volume).

The parameter may (at least) indicate QoS (related) level/requirement/characteristic(s) allowed to use the S&F operation. The parameter may (at least) indicate a maximum QoS level (e.g., latency) that the NW can fulfill. The parameter may (at least) indicate how long (e.g., the delay, the latency) the data (or signaling) received from the UE is expected to be stored by the NW before being delivered. The parameter may (at least) indicate how long (e.g., the delay, the latency) the response of a UE request is (expected to be) transmitted (or received). The parameter may (at least) indicate how long (e.g., the delay, the latency) the service would be delayed by the S&F operation.

The UE may determine (whether) to use the S&F operation (e.g., for a specific object, for a service, for a PDU session) based on (at least) the configuration. For example, if the UE receives the configuration and/or the object of the UE (or the service, or the PDU session) is included in the configuration (or pre-configuration), the UE may consider the S&F operation is (or is not) enabled (and/or activated, and/or allowed), e.g., for the object, for the service, and/or for the PDU session. If the UE receives the configuration and/or the object of the UE (or the service, or the PDU session) is not included in the configuration (or pre-configuration), the UE may consider the S&F operation is not (or is) enabled (and/or activated, and/or allowed), e.g., for the object, for the service, and/or for the PDU session. If the UE receives the configuration and/or the object of the UE (or the service, or the PDU session) could fulfill the condition/limitation/restriction/requirement of the configuration (or pre-configuration), the UE may consider the S&F operation is enabled (and/or activated, and/or allowed), e.g., for the object, for the service, and/or for the PDU session. If the UE receives the configuration and/or the object of the UE (or the service, or the PDU session) cannot fulfill the condition/limitation/restriction/requirement of the configuration (or pre-configuration), the UE may consider the S&F operation is not (or is) enabled (and/or activated, and/or allowed), e.g., for the object, for the service, and/or for the PDU session. If the UE does not receive the configuration, the UE may consider the S&F operation is (or is not) enabled (and/or activated, and/or allowed), e.g., for every (or all) object of the UE (or the service, or the PDU session).

If the UE considers the S&F operation is allowed/enabled/activated for an object (or a service, or a PDU session), the UE may perform transmission (and/or reception) of the object (or the service, or the PDU session) (e.g., using the S&F operation), initiate a procedure to (or for) perform a transmission (and/or reception) of the object (or the service, or the PDU session) (e.g., using the S&F operation), and/or to a request permission/establishment/resource for the object (or the service, or the PDU session) (e.g., using the S&F operation). If the UE considers the S&F operation is not allowed/enabled/activated for an object (or a service, or a PDU session), the UE may not perform a transmission (and/or reception) of the object (or the service, or the PDU session) (e.g., using S&F operation), not initiate a procedure to (or for) performing transmission (and/or reception) of the object (or the service, or the PDU session) (e.g., using the S&F operation), and/or not request permission/establishment/resource for the object (or the service, or the PDU session) (e.g., using the S&F operation). The procedure may be a registration procedure (e.g., for an initial and/or mobility update), attach, a service request procedure, a PDU session establishment (or modification) procedure.

To determine whether a service (or PDU session, or UE) is allowed to use the S&F operation, at least an object of the service (or PDU session, or UE) needs to fulfill the configured QoS. For example, if no object of the service (or PDU session, or UE) fulfills the configured QoS, the UE may not be allowed to use the S&F operation for the service (or PDU session, or UE). If every object of the service (or PDU session, or UE) fulfills the configured QoS, the UE may be allowed to use the S&F operation for the service (or PDU session, or UE). If some object(s) of the service (or PDU session, or UE) (e.g., a first object) fulfills the configured QoS and some other object(s) of the service (or PDU session, or UE) (e.g., a second object) does not fulfill the configured QoS, the UE may be allowed to use the S&F operation for the first object and not allowed to use the S&F operation for the second object. If some object(s) of the service (or PDU session, or UE) (e.g., a first object) fulfills the configured QoS and some other object(s) of the service (or PDU session, or UE) (e.g., a second object) does not fulfill the configured QoS, the UE may not be allowed to use the S&F operation for the service (or PDU session, or UE) (e.g., including the first object and the second object). If some object(s) of the service (or PDU session, or UE) (e.g., a first object) fulfills the configured QoS and some other object(s) of the service (or PDU session, or UE) (e.g., a second object) does not fulfill the configured QoS, the UE may be allowed to use the S&F operation for the service (or PDU session, or UE) (e.g., including the first object and the second object).

The object may be (or comprise) (at least) a connection, a service, a PDU session, and/or a QoS flow. The object may be (or comprise) (at least) a radio bearer, RLC bearer, and/or logical channel.

### Data Volume

The configuration may (at least) indicate data volume limitation allowed to use the S&F operation. The configuration may (at least) indicate how much data that can be transmitted to the NW (e.g., using the S&F operation). The data may be (or comprise) UP data and/or CP signaling. The data may be AS level and/or NAS level.

The configuration may be (at least) based on (or identified by/represented by/specific to) a UE, a connection, a service(s), a PDU session(s), and/or a QoS flow(s). The configuration may (at least) indicate what (or which) UE, connection(s), service(s), PDU session(s), and/or QoS flow(s) is associated to the configuration. The configuration may be (at least) based on (or identified by/represented by/specific to) a radio bearer(s) (SRB and/or DRB), RLC bearer(s), and/or logical channel(s). The configuration may (at least) indicate what (or which) radio bearer(s), RLC bearer(s), and/or logical channel(s) is associated to the parameter.

The UE may determine (whether) to use the S&F operation (e.g., for a specific object) based on (at least) the configuration. The UE may determine (whether) to stop the S&F operation (e.g., for a specific object) based on (at least) the configuration. The UE may determine (whether) the S&F operation (e.g., for a specific object) can continue based on (at least) the configuration.

The object may be (or comprise) (at least) a UE, a connection, a service, a PDU session, and/or a QoS flow. The object may be (or comprise) (at least) a radio bearer, RLC bearer, and/or logical channel.

For example, if the UE receives the configuration and/or the traffic of the UE (e.g., for the object) has not exceeded the data volume, the UE may (be allowed to) use the S&F operation, e.g., for the traffic. If the UE receives the configuration and/or the traffic of the UE (e.g., for the object) has exceeded the data volume, the UE may not (be allowed to) use the S&F operation, e.g., for the traffic. If the UE does not receive the configuration, the UE may consider there is no data volume limitation to use the S&F operation, e.g., for the UE, for the object.

If the UE considers that the S&F operation is allowed (e.g., for a traffic), the UE may perform (or continue) transmission (and/or reception) of the traffic (e.g., using the S&F operation), initiate (or continue) a procedure to (or for) performing transmission (and/or reception) of the traffic (e.g., using the S&F operation), and/or to request permission/establishment/resource for the traffic (e.g., using the S&F operation). The procedure may be a registration procedure (e.g., for initial and/or mobility update), a service request procedure, a PDU session establishment (or modification) procedure.

If the UE has transmitted data exceeding the data volume, the UE may stop the S&F operation, stop transmitting data, stop the (ongoing) procedure. If the UE has transmitted data exceeding the data volume, the UE may transmit an indication to the NW (e.g., indicating that the data volume limitation is reached), initiate a (RRC and/or NAS) connection release (request) procedure, initiate a de-registration procedure, and/or initiate a PDU session release (or modification) procedure (e.g., to release a PDU session). If the UE has transmitted data exceeding the data volume, the UE may release a (RRC and/or NAS) connection, and/or go to (RRC and/or NAS) idle mode (e.g., RRC_IDLE, Connection Management (CM)_IDLE).

The S&F operation may be (or comprise) (at least) one or more of the following:
The UE may know (or be informed by NW) that the NW is (or starts) using S&F to handle data (and/or signaling);
The UE may initiate a procedure to request (or indicate) the (satellite) NW to use S&F to handle data (and/or signaling);
The UE may perform data (and/or signaling) transmission that will be handled by S&F in the (satellite) NW; and/or
The UE may (be ready to) perform data (and/or signaling) reception that is stored in the (satellite) NW.

A UE and/or a network node may be in S&F mode (or use the S&F operation) if at least one or more of the following conditions are fulfilled:
The feeder link (of the UE and/or the network node) is not available;
An indication of S&F mode (and/or to enable S&F mode) is received (or transmitted);
A configuration related to S&F mode (and/or enabled) is received (or transmitted); and/or
S&F mode (of the UE and/or the network node) is enabled and/or activated.

The UE and/or the network node may be in normal mode (e.g., compared to S&F mode) if at least one or more of the following conditions are fulfilled:
The feeder link (of the UE and/or the network node) is available;
No indication of S&F mode is received (or transmitted);
An indication to disable (or deactivate) S&F mode is received (or transmitted);
No configuration related to S&F mode (and/or enabled) is received (or transmitted);
A configuration to disable (or deactivate) S&F mode is received (or transmitted); and/or
S&F mode (of the UE and/or the network node) is disabled and/or deactivated.

The UE and/or the network node may enter S&F mode from normal mode, and/or leave S&F mode to enter normal mode.

When the UE and/or the network node is in S&F mode (or use the S&F operation), at least one or more of the following may be performed:
The UE may know (or be informed by NW) that the NW is (or starts) using S&F to handle data (and/or signaling);
The UE may initiate a procedure to request (or indicate) the (satellite) NW to use S&F to handle data (and/or signaling);
The UE may perform data (and/or signaling) transmission that will be handled by S&F in the (satellite) NW; and/or
The UE may (be ready to) perform data (and/or signaling) reception that is stored in the (satellite) NW.

To support the S&F operation, the satellite NW (e.g., NG-RAN, or Secondary eNB (SeNB) in [4] RWS-230178) needs to provide at least some level of service (and/or network access) to one or more UE(s) under the condition of no feeder link (connected to the ground NW, such as CN or gateway in [4] RWS-230178). To this end, the satellite NW and the ground NW may require some negotiation in advance (e.g., when the feeder link of the satellite NW is available) about how to provide the service (and/or network access).

To solve the issue, the satellite NW could be provided with (at least) some configuration related to the S&F operation by the ground NW. The satellite NW may transmit a request (or an indication) of the S&F operation to the ground NW (e.g., in advance). The ground NW may accept (or reject) the request of S&F, and/or provide a configuration of the S&F operation to the satellite NW (e.g., in response to the request or the indication). After receiving the configuration of the S&F operation, the satellite NW may start the S&F operation (and/or provide S&F service to a UE) when there is no feeder link with the ground NW. An example is shown in FIG. 15.

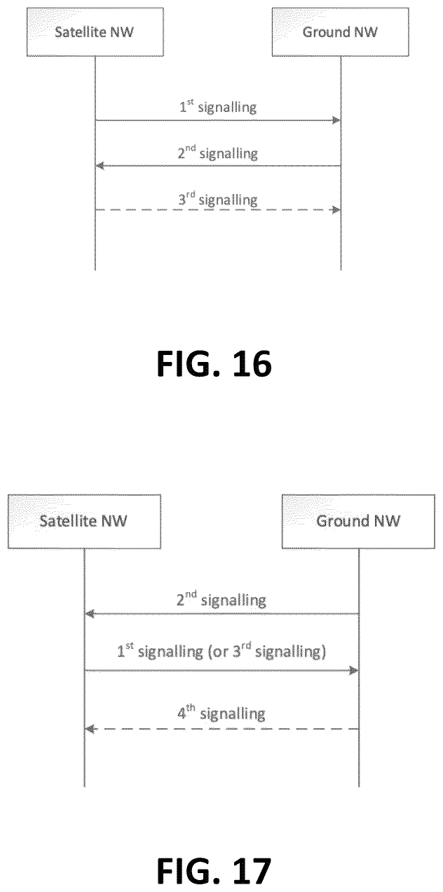

In one or more examples, the satellite NW may connect to the ground NW via a feeder link. The satellite NW may want to communicate/negotiate/handshake with the ground NW about the S&F operation, e.g., whether to start the S&F operation, whether the S&F operation can be used, whether the S&F operation can be supported. The satellite NW may not use (or start) the S&F operation before. The satellite NW may want to use (or start) the S&F operation. The satellite NW may want to prepare the S&F operation. The satellite NW may want to obtain one or more configuration(s) related to S&F, e.g., for future use. The satellite NW may initiate a procedure for this purpose. After the procedure is completed (successfully), the satellite NW may start the S&F operation. An example of the procedure is shown in FIG. 16.

In one or more examples, the satellite NW may connect to the ground NW via a feeder link. The satellite NW may regain (or recover) a feeder link with the ground NW. The ground NW may or may not be the same ground NW as it connected to last time. The satellite NW may want to transmit (or forward) some (temporally stored) data/signaling/message to the ground NW. The data/signaling/message may be received by one or more UEs before, e.g., in the S&F operation, when the feeder link is not available. The satellite NW may initiate a procedure for this purpose. After the procedure is completed (successfully), the satellite NW may transmit the data/signaling/message to the ground NW. An example of the procedure is shown in FIG. 16.

In one or more examples, the satellite NW may connect to the ground NW via a feeder link. The satellite NW may regain (or recover) a feeder link with the ground NW. The ground NW may or may not be the same ground NW as it connected to last time. The ground NW may want to transmit (or forward) some data/signaling/message to the satellite NW. The data/signaling/message may be for one or more UEs. The data/signaling/message may be stored by the satellite NW (temporally). The data/signaling/message may be forwarded to the one or more UEs via the satellite NW. The ground NW may initiate a procedure for this purpose. After the procedure is completed (successfully), the ground NW may transmit the data/signaling/message to the satellite NW. An example of the procedure is shown in FIG. 17.

The satellite NW may transmit a first signaling to the ground NW, e.g., during the procedure mentioned above, or illustrated in FIG. 16 or FIG. 17. The first signaling may be transmitted via a feeder link. The first signaling may be (or comprise) an indication of the S&F operation. The first signaling may be (or comprise) a request of using the S&F operation. The first signaling may be initiated by the satellite NW, e.g., without receive a signaling from the ground NW. The first signaling may be in response to a signaling (e.g., the second signaling) from the ground NW.

The satellite NW may transmit a third signaling to the ground NW, e.g., during the procedure mentioned above, or illustrated in FIG. 16 or FIG. 17. The third signaling may be transmitted via a feeder link. The third signaling may be in response to a signaling (e.g., the second signaling) from the ground NW.

The feeder link may be (or correspond to) an NG interface (e.g., NG-User Plane Interface (U), NG-Core (C), NG-Application Protocol (AP)), F1 interface (e.g., F1-U, F1-C), an N2 reference point, and/or an N3 reference point.

(At least) one or more of the following information may be included (or used) in the first signaling and/or the third signaling. The one or more of the following information may be mandatory or optional in the first signaling (and/or the third signaling). The one or more of the following information may be absent (or not included) in the first signaling (and/or the third signaling). The one or more of the following information may be provided to a UE (e.g., as a configuration of S&F).

### Indication of an S&F Operation

The first signaling (or the indication) may indicate that the satellite NW is (about to) using the S&F operation. The first signaling (or the indication) may indicate that the satellite NW prepares to use the S&F operation. The first signaling (or the indication) may indicate that the satellite NW has been using the S&F operation. The first signaling (or the indication) may indicate that the satellite NW is returning (to normal operation) from the S&F operation. (The normal operation may be (or similar to) the normal/default Satellite operation specified in TR 22.865 ([2] 3GPP TR 22.865 V2.0.0).

The first signaling (or the indication) may indicate that the satellite NW has stored data/signaling/message to be forwarded to the ground NW. The stored data/signaling/message may be received by one or more UEs, e.g., when the feeder link of the satellite NW is not available.

The first signaling (or the indication) may indicate that the satellite NW is ready to receive data/signaling/message to be forwarded to the UE(s).

### Request of an S&F Operation

The first signaling (or the request) may be used to request (a permission of using) the S&F operation. The first signaling (or the request) may be used to request the S&F configuration, e.g., for initiating the S&F operation, for updating the S&F configuration. The S&F configuration may be (or comprise) one or more configuration(s) related to S&F mentioned in this disclosure. The first signaling (or the request) may be used to request to return (to normal operation) from the S&F operation. (The normal operation may be (or similar to) the normal/default Satellite operation specified in TR 22.865 ([2] 3GPP TR 22.865 V2.0.0).

The first signaling (or the request) may be used to request (a permission) of forwarding data/signaling/message stored in the satellite NW to the ground NW.

The first signaling (or the request) may be used to request (a permission) of receiving data/signaling/message stored in the ground NW to be forwarded to the UE(s).

The first signaling (or the request) may be used to request one or more of the information mentioned below (e.g., time information, neighbor satellite or satellite NW information, S&F configuration, UE information, service information, QoS information, data/signaling/message for forwarding).

### Response of an S&F Operation

The first signaling (or the response) may be in response to a second signaling (e.g., as mentioned below). The first signaling (or the response) may be in response to a request in the second signaling (e.g., as mentioned below). The first signaling (or the response) may be used to acknowledge, accept, or reject a request (of the S&F operation) from the ground NW.

The first signaling (or the response) may be used to respond a query from the ground NW that if (or whether) the satellite NW could forward data/signaling/message to a UE.

### Time Information

The first signaling (or the time information) may indicate when (and/or how long) the feeder link (of the satellite NW) is (or will be) not available. The first signaling (or the time information) may indicate when (and/or how long) the S&F operation is (or will be) used. The time information may be an estimate by the satellite NW. The time information may be (or comprise) a start time, an end time, and/or a duration. The time information may be derived (or calculated, or estimated) from satellite information (e.g., ephemeris) of a satellite where the satellite NW is located. The time information may be optional in the first signaling.

### Neighbor Satellite (or Satellite NW) Information

The first signaling (or the information) may be (or comprise) information related to a neighboring satellite (or the satellite NW). The neighboring satellite (or satellite NW) may have an Inter-Satellite Link (ISL) with the satellite NW. The satellite NW may be able to communicate (or connect) with the neighboring satellite (or satellite NW) via one or more ISL(s).

The information may be (or comprise) ephemeris information of a neighbor satellite. The information may be (or comprise) a list of ephemeris information for a list of neighbor satellites. An ephemeris information in the list may correspond to a neighbor satellite.

The information may be (or comprise) network identity of a neighbor satellite NW. The information may be (or comprise) a list of network identities for a list of neighbor satellite NWs (nodes). A network identity in the list may correspond to a neighbor satellite NW (node).

### S&F Configuration

The first signaling (or the information) may be (or comprise) S&F configuration of the satellite NW. The S&F configuration may be used by the satellite NW, e.g., currently, in the S&F operation, before, in the previous S&F operation. The configuration may be one or more of the S&F configurations mentioned in this disclosure.

### UE Information

The first signaling (or the information) may be (or comprise) information related to one or more UE(s). The UE(s) may be served by the satellite NW, e.g., currently, in the S&F operation, before, in the previous S&F operation. The UE(s) may have data/signaling/message stored in the satellite NW. The UE(s) may be (or is likely to be) served by the satellite NW, e.g., in the future, in the next S&F operation.

The information may be (or comprise) a UE identifier (or a UE identity) of a UE. The information may be (or comprise) a list of UE identifiers for a list of UEs. A UE identifier (or UE identity) in the list may correspond to a UE.

The UE identifier (or UE identity) may be (or comprise) (at least) a Subscription Permanent Identifier (SUPI), International Mobile Subscriber Identity (IMSI), Global Unique Temporary Identifier (GUTI), 5G Global Unique Temporary Identifier (5G-GUTI), Subscription Concealed Identifier (SUCI), Permanent Equipment Identifier (PEI), Radio Network Temporary Identifier (RNTI), Cell Radio Network Temporary Identifier (C-RNTI), Inactive Radio Network Temporary Identifier (I-RNTI), and/or a portion of the above.

The information may be (or comprise) UE context of a UE. The information may be (or comprise) a list of UE context for a list of UEs. A UE context in the list may correspond to a UE.

The UE context may be (or comprise) (at least) AS configuration, RRC configuration, AS context, UE capability, Radio Resource Management (RRM) configuration, and/or a portion of the above.

The information may be (or comprise) a configuration of a UE. The information may be (or comprise) a list of configurations for a list of UEs. A configuration in the list may correspond to a UE. The configuration may be related to S&F. The configuration may be (or comprise) (at least) one or more of the S&F configurations mentioned in this disclosure.

### Service and/or QoS Related Information

The first signaling (or the information) may be (or comprise) information related to one or more services and/or QoSs. The service and/or QoS may be that which can be supported by the satellite NW in the S&F operation. The service may be (or comprise) delay-tolerant. The service may be (or comprise) non real-time.

The information may be (or comprise) (at least) one or more QoS parameter(s) mentioned in this disclosure.

### Stored Data/Signaling/Message

The first signaling may comprise (one or more) data/signaling/message stored in the satellite NW. The data/signaling/message is to be forwarded to the ground NW. The data/signaling/message may be received from one or more UEs when the satellite NW has no feeder link, e.g., in the S&F operation. The data/signaling/message may be associated to one or more UEs.

The data/signaling/message may be (user plane) data, control signaling, upper layer signaling, a NAS message, an RRC message, a NAS PDU, a NAS Service Data Unit (SDU), an Internet Protocol (IP) packet, a Packet Data Convergence Protocol (PDCP) SDU, and/or a PDCP PDU.

In one or more examples, the satellite NW may transmit a request of transmitting stored data/signaling/message to the ground NW (e.g., via the first signaling). The ground NW may transmit a response to the satellite NW indicating the request is accepted (or rejected) and/or some related configuration (e.g., forwarding priority) (e.g., via the second signaling). When/if/in response to the response, the satellite NW may transmit the stored data/signaling/message to the ground NW, e.g., based on the related configuration provided by the ground NW (e.g., via the third signaling).

The first signaling (and/or the third signaling) may be initiated (or triggered) by (at least) one or more of the following conditions:
The feeder link of the satellite NW is available;
The condition may be when/if/upon/in response to feeder link is (or becomes) available. The satellite NW may return from not available to available. The satellite NW may be in the S&F operation when the feeder link is not available. The satellite NW may not be in the S&F operation when the feeder link is not available.
he satellite NW is about to lose its feeder link;
The satellite NW would like to use (or start) the S&F operation;
The satellite NW would like to modify (the current) S&F operation;
The satellite NW has stored data/signaling/message;
The satellite NW is (or has been) notified by the ground NW; and/or
When/if/upon/in response to the second signaling (or a request).

The first signaling (and/or the third signaling) may be (or comprise) (at least) an AMF configuration update, a RAN configuration update, an initial context setup request/response, an NG reset, an NG setup request/response, a PDU session resource setup/modify request/response, a UE context modification/suspend/resume request/response, a downlink/uplink RAN configuration transfer, a UE information transfer, and/or the like.

The procedure may be (or comprise) (at least) an AMF configuration update, a RAN configuration update, an initial context setup, an NG reset, an NG setup, a PDU session resource setup/modify, a UE context modification/suspend/resume, a downlink/uplink RAN configuration transfer, a UE information transfer, and/or the like.

The ground NW may transmit a second signaling to the satellite NW, e.g., during the procedure mentioned above, or illustrated in FIG. 16 or FIG. 17. The second signaling may be transmitted via a feeder link. The second signaling may be a response of the first signaling. The ground NW may transmit the second signaling in response to receiving the first signaling (e.g., from the satellite NW). The second signaling may be initiated by the ground NW, e.g., without receive a signaling from the satellite NW.

The ground NW may transmit a fourth signaling to the satellite NW, e.g., during the procedure mentioned above, or illustrated in FIG. 16 or FIG. 17. The fourth signaling may be transmitted via a feeder link. The fourth signaling may be in response to a signaling (e.g., the first signaling or the third signaling) from the satellite NW.

The feeder link may be (or correspond to) an NG interface (e.g., NG-U, NG-C, NG-AP), an F1interface (e.g., F1-U, F1-C), an N2 reference point, and/or an N3 reference point.

(At least) one or more of the following information may be included in the second signaling and/or the fourth signaling. The one or more of the following information may be mandatory or optional in the second signaling (and/or the fourth signaling). The one or more of the following information may be absent (or not included) in the second signaling (and/or the fourth signaling). The one or more of the following information may be provided to a UE (e.g., as a configuration of S&F).

### Indication of an S&F Operation

The second signaling (or the indication) may indicate that the ground NW acknowledges that the satellite NW is (about to) using the S&F operation. The second signaling (or the indication) may indicate that the ground NW could support the satellite NW to use the S&F operation. The second signaling (or the indication) may indicate that the ground NW has been supporting the satellite NW using the S&F operation. The second signaling (or the indication) may indicate that the ground NW could not support the satellite NW to use the S&F operation.

The second signaling (or the indication) may indicate that the ground NW has data/signaling/message for one or more UE(s), and/or the data/signaling/message is to be forwarded (to the one or more UEs) by the satellite NW. The one or more UEs may not be served by the satellite NW currently. The one or more UEs may be served by the satellite NW in the future, e.g., at a later time. The data/signaling/message may be forwarded to the one or more UEs in the future, e.g., at a later time, when the one or more UEs are served by the satellite NW.

The second signaling (or the indication) may indicate that the ground NW is ready to receive data/signaling/message (from one or more UEs) that is stored in the satellite NW (temporally). The satellite NW may forward the data/signaling/message (from one or more UEs) to the ground NW, e.g., after receiving the second signaling (or the indication).

### Response of an S&F Operation

The second signaling (or the response) may be used to acknowledge, accept, or reject a request of the S&F operation from the satellite NW. If the ground NW accepts the request, the satellite NW may use the S&F operation, e.g., when the feeder link of the satellite NW is not available. If the ground NW rejects the request, the satellite NW may not use the S&F operation, e.g., until the S&F operation is accepted.

The second signaling (or the response) may be used to acknowledge, accept or reject a request of forwarding data/signaling/message stored in the satellite NW to the ground NW.

The second signaling (or the response) may be used to acknowledge, accept, or reject a request of transmitting data/signaling/message stored in the ground NW to be forwarded to UE(s).

### Request of an S&F Operation

The second signaling (or the request) may be used to request (a permission) of transmitting data/signaling/message (for one or more UEs) to be forwarded by the satellite NW. The one or more UEs may not be served by the satellite NW currently. The one or more UEs may be served by the satellite NW in the future, e.g., at a later time. The data/signaling/message may be forwarded to the one or more UEs in the future, e.g., at a later time, when the one or more UEs are served by the satellite NW.

The second signaling (or the request) may be used to query if (or whether) the satellite NW could forward data/signaling/message to a UE. The ground NW may have data/signaling/message to be sent to the UE. The ground NW may transmit the data/signaling/message to the satellite NW, e.g., after/if/in response to the query (or the request) being accepted by the satellite NW.

The second signaling (or the request) may be used to request one or more of the information mentioned below (e.g., time information, neighbor satellite or satellite NW information, S&F configuration, UE information, service information, QoS information, data/signaling/message for forwarding).

### S&F Configuration

The second signaling (or the information) may be (or comprise) one or more configuration(s) related to S&F. The one or more configuration(s) may be used by the satellite NW.

The satellite NW may store the one or more configuration(s), e.g., when/upon/after/in response to receiving the second signaling (or the configuration). The satellite NW may apply the one or more configuration(s), e.g., when/upon/if/in response to the feeder link of the satellite NW is not available, when/upon/if/in response to the satellite NW starts to use the S&F operation. The satellite NW may update its current configuration(s) by the one or more configuration(s) received in the second signaling, e.g., if the satellite NW has been configured with some S&F configurations.

The ground NW may provide one or more configuration(s) related to S&F to the satellite NW, e.g., when/if/upon/in response to the ground NW accepting the request of the S&F operation.

The configuration may be one or more of the S&F configurations mentioned in this disclosure.

### UE Information

The second signaling (or the information) may be (or comprise) (at least) information related to one or more UE(s). The ground NW may have data/signaling/message to be sent to the UE(s). The data/signaling/message may be forwarded to the UE(s) by the satellite NW. The UE(s) may be (or is likely to be) served by the satellite NW, e.g., in the future, in the next S&F operation. The UE(s) may be served by the satellite NW, e.g., currently, in the S&F operation, before, in the previous S&F operation.

The information may be (or comprise) (at least) a UE identifier (or UE identity) of a UE. The information may be (or comprise) a list of UE identifiers for a list of UEs. A UE identifier (or UE identity) in the list may correspond to a UE.

The UE identifier (or UE identity) may be (or comprise) (at least) a SUPI, IMSI, GUTI, 5G-GUTI, SUCI, PEI, RNTI, C-RNTI, I-RNTI, and/or a portion of the above.

The information may be (or comprise) (at least) UE context of a UE. The information may be (or comprise) a list of UE context for a list of UEs. A UE context in the list may correspond to a UE.

The UE context may be (or comprise) (at least) AS configuration, RRC configuration, AS context, UE capability, RRM configuration, and/or a portion of the above.

The information may be (or comprise) (at least) a configuration of a UE. The information may be (or comprise) a list of configurations for a list of UEs. A configuration in the list may correspond to a UE. The configuration may be related to S&F. The configuration may be one or more of the S&F configuration mentioned in this disclosure.

### Service and/or QoS Related Information

The second signaling (or the information) may be (or comprise) information related to one or more services and/or QoSs. The service and/or QoS may be that which is to be supported by the satellite NW in the S&F operation. The service may be (or comprise) delay-tolerant. The service may be (or comprise) non real-time.

The information may be (or comprise) (at least) one or more QoS parameter(s) mentioned in this disclosure.

### Data/Signaling/Message (to be Forwarded or Stored)

The second signaling may comprise (one or more) data/signaling/message (to be stored in the satellite NW). The data/signaling/message is to be forwarded to one or more UEs. The data/signaling/message may be transmitted to one or more UEs when the satellite NW has no feeder link, e.g., in the S&F operation. The data/signaling/message may be associated to one or more UEs.

The data/signaling/message may be (user plane) data, control signaling, upper layer signaling, a NAS message, an RRC message, a NAS PDU, a NAS SDU, an IP packet, a PDCP SDU, and/or a PDCP PDU.

### Time Information

The second signaling (or the time information) may indicate when (and/or how long) the feeder link (of the satellite NW) is (or will be) not available. The first signaling (or the time information) may indicate when (and/or how long) the S&F operation is (or will be) used. The time information may be an estimate by the satellite NW. The time information may be (or comprise) a start time, an end time, and/or a duration. The time information may be derived (or calculated, or estimated) from satellite information (e.g., ephemeris) of a satellite where the satellite NW is located.

The time information may be optional in the first signaling.

### Neighbor Satellite (or Satellite NW) Information

The second signaling (or the information) may be (or comprise) information related to a neighboring satellite (or the satellite NW). The neighboring satellite (or satellite NW) may have an ISL with the satellite NW. The satellite NW may be able to communicate (or connect) with the neighboring satellite (or the satellite NW) via one or more ISLs.

The information may be (or comprise) ephemeris information of a neighbor satellite. The information may be (or comprise) a list of ephemeris information for a list of neighbor satellites. An ephemeris information in the list may correspond to a neighbor satellite.

The information may be (or comprise) network identity of a neighbor satellite NW. The information may be (or comprise) a list of network identities for a list of neighbor satellite NWs (nodes). A network identity in the list may correspond to a neighbor satellite NW (node).

In one or more examples, the ground NW may transmit a request of transmitting data/signaling/message to the satellite NW (e.g., via the second signaling, for forwarding to one or more UEs). The satellite NW may transmit a response to the ground NW indicating the request is accepted (or rejected) and/or some related configuration (e.g., forwarding priority, data retention period, data storage quota) (e.g., via the first signaling, via the third signaling). When/if/in response to the response, the ground NW may transmit the stored data/signaling/message to the satellite NW, e.g., based on the related configuration provided by the satellite NW (e.g., via the fourth signaling).

The second signaling (and/or the third signaling) may be initiated (or triggered) by (at least) one or more of the following conditions:
Feeder link of the satellite NW is available;
The condition may be when/if/upon/in response to the feeder link is (or becomes) available. The satellite NW may return from not available to available. The satellite NW may be in the S&F operation when the feeder link is not available. The satellite NW may not be in the S&F operation when the feeder link is not available.
The ground NW would like to use (or start) the S&F operation;
The ground NW would like to modify (the current) S&F operation;
The ground NW has data/signaling/message to be forwarded or stored;
The ground NW is (or has been) notified by the satellite NW; and/or
When/if/upon/in response to the first signaling or the third signaling (or a request).

The second signaling (and/or the fourth signaling) may be (or comprise) (at least) an AMF configuration update, a RAN configuration update, an initial context setup request/response, an NG reset, an NG setup request/response, a PDU session resource setup/modify request/response, a UE context modification/suspend/resume request/response, a downlink/uplink RAN configuration transfer, a UE information transfer, and/or the like.

The procedure may be (or comprise) (at least) an AMF configuration update, a RAN configuration update, an initial context setup, an NG reset, an NG setup, a PDU session resource setup/modify, a UE context modification/suspend/resume, a downlink/uplink RAN configuration transfer, a UE information transfer, and/or the like.

The S&F configuration may be (or comprise) one or more of the following information. The S&F configuration may be specific to a satellite or a satellite NW. The S&F configuration may be specific to a satellite or a UE.
Data retention period;
The information may be (or indicate) how long the data/signaling/message (in total or for a UE) could be stored in the satellite (or satellite NW). The data/signaling/message may be discarded (by the satellite NW) if the data/signaling/message has been stored for too long (e.g., exceeding the data retention period).
Data storage quota;
The information may be (or indicate) how much data/signaling/message (in total or for a UE) could be stored in the satellite (or satellite NW). Some data/signaling/message may be discarded (by the satellite NW) if too much data/signaling/message has been stored in the satellite NW (e.g., exceeding the data storage quota).
Forwarding priority; and/or
The information may be (or indicate) what type of data/signaling/message (in total or for a UE) should be forwarded first. The data/signaling/message with higher priority is forwarded first (e.g., prioritized over the data/signaling/message with lower priority).
Acknowledgement policy.
The information may be (or indicate) whether the data/signaling/message needs acknowledgement.

After (or in response to) receiving the S&F configuration from the ground NW, the satellite NW may provide (or broadcast) an indication and/or a configuration related to S&F (e.g., before the UE transmits data to the NW) in a signaling. The signaling is transmitted via a service link. The UE could determine whether and/or how to transmit data and/or signaling (e.g., using the S&F operation) based on (at least) the indication and/or the configuration. For example, if the UE detects that the NW is using the S&F operation (e.g., the feeder link is not available currently), the UE may use the S&F operation, and/or not generate (or transmit) data (or signaling) that is not suitable for the S&F operation (e.g., the QoS requirement such as delay requirement cannot be fulfilled) to the NW.

If the UE receives (the signaling with) the indication and/or the configuration related to S&F (e.g., the indication and/or the configuration is present and/or enabled), the UE may consider that the NW (e.g., the satellite NW) is using the S&F operation, under S&F mode, the feeder link of the NW is not available, and/or the NW is not able to forward data/signaling to ground NW. The UE may use (or enable) the S&F operation (in response).

If the UE does not receive the signaling, does not receive the indication and/or the configuration related to S&F, and/or the indication and/or the configuration is absent and/or disabled, the UE may consider that the NW (e.g., the satellite NW) is not using the S&F operation, not under S&F mode, the feeder link of the NW is available, and/or the NW is able to forward data/signaling to ground NW. The UE may not use (or disable) the S&F operation (in response).

The indication and/or the configuration related to S&F may be provided (by the NW, e.g., the satellite NW) (to the UE) in a broadcast signaling, e.g., system information, paging. The UE may acquire the broadcast signaling upon (or in response to) camping/selecting/reselecting a cell, a handover (to the cell), a serving cell change (to the cell), and/or informed by the NW (e.g., notification of system information change).

The indication and/or the configuration related to S&F may be provided (by the NW, e.g., satellite NW) (to the UE) in a dedicated signaling. The dedicated signaling may be a NAS message or an RRC message. The dedicated signaling may be a reconfiguration message (e.g., RRC reconfiguration message). The dedicated signaling may be a NAS notification message. The dedicated signaling may be a paging message.

The dedicated signaling may be a response message to a UE request. The dedicated signaling may be a NAS message or an RRC message. The UE request may be a request message to establish an RRC connection, a NAS connection, and/or a PDU session. The UE request may be a service request.

The indication and/or the configuration related to S&F may (or may not) be provided during a procedure (e.g., between the UE and the NW). The procedure may be initiated by the UE. The procedure may be initiated by the NW. The procedure may (or may not) be a registration procedure. The registration procedure may (or may not) be for initial registration. The registration procedure may (or may not) be for mobility registration update. The registration procedure may (or may not) be for periodic registration update. The procedure may (or may not) be a service request procedure. The procedure may (or may not) be a notification procedure. The procedure may (or may not) be a PDU session establishment procedure. The procedure may (or may not) be a PDU session modification procedure.

The NW may determine whether to provide the indication and/or the configuration related to S&F based on (at least) whether the feeder link of the NW is available or not. For example, if the NW receives a UE request from the UE (e.g., to establish/modify an RRC connection, a NAS connection, and/or a PDU session), the NW may determine (whether) to accept (or reject) the UE request based on (at least) whether the feeder link of the NW is available, and/or whether the UE request (e.g., the corresponding connection, PDU session, and/or QoS flow) can be operated in the S&F operation (e.g., whether the corresponding QoS requirement can be fulfilled). If yes, the NW may accept the UE request. The NW may provide the indication and/or the configuration related to S&F in the accept message. If no, the NW may reject the UE request. The NW may provide a reject cause in the reject message to the UE. The reject cause may be related to the S&F operation, e.g., the feeder link is not available.

The NW may be the satellite NW. The satellite NW may be a network node, a CN node, a RAN node, AMF, SMF, MME, RAN, NG-RAN, eNB, gNB, a portion of the above, and/or a combination of the above.

The NW may be the ground NW. The ground NW may be a network node, a CN node, a RAN node, AMF, SMF, MME, RAN, NG-RAN, eNB, gNB, a portion of the above, and/or a combination of the above.

The satellite NW and the ground NW may be mutually exclusive.

The NW may be a cell. The NW may be a serving cell. The NW may be a neighbor cell. The NW may be a source cell. The NW may be a target cell.

The UE may be in RRC connected mode. The UE may be in RRC idle mode. The UE may be in RRC inactive mode.

The UE may be in CM idle state. The UE may be in CM connected state.

The UE may be in RM deregistered state. The UE may be in RM registered state.

The UE may be in a cell of the NTN. The UE may be connected to a cell of the NTN. The UE may be connected to a LEO, GEO, MEO, HEO, and/or HAPS.

The UE may be referred to as the UE, an RRC entity of the UE, or a MAC entity of the UE.

The UE may be an NR device. The UE may be an NR-light device. The UE may be a reduced capability device. The UE may be a mobile phone. The UE may be a wearable device. The UE may be a sensor. The UE may be a stationary device.

The network (NW) may be a network node. The network (NW) may be a base station. The network (NW) may be an access point. The network (NW) may be an eNB. The network (NW) may be a gNB. The network (NW) may be a gateway. The network (NW) may be an MME. The network (NW) may be an SGW. The network (NW) may be a PGW. The network (NW) may be an AMF. The network (NW) may be a UPF. The network (NW) may be an HSS.

The procedure may be (or comprise) a NAS procedure.

The procedure (e.g., the NAS procedure) may be (or comprise) a registration procedure. The procedure (e.g., the NAS procedure) may be (or comprise) a deregistration procedure.

The registration procedure may be for initial registration. The UE may be in RM-DEREGISTERED state.

The registration procedure may be for mobility registration. The registration procedure may be for periodic registration.

The registration procedure may be for emergency registration. The registration procedure may be for disaster roaming registration.

The procedure (e.g., the NAS procedure) may be (or comprise) a service request procedure.

The procedure (e.g., the NAS procedure) may be (or comprise) a (UE-requested) PDU session establishment procedure. The procedure (e.g., the NAS procedure) may be (or comprise) a (UE-requested) PDU session modification procedure. The procedure (e.g., the NAS procedure) may be (or comprise) a (UE-requested) PDU session release procedure.

The procedure (e.g., the NAS procedure) may be (or comprise) a NAS transport procedure.

The procedure (e.g., the NAS procedure) may be (or comprise) an attach procedure. The procedure (e.g., the NAS procedure) may be (or comprise) a detach procedure.

The procedure (e.g., the NAS procedure) may be (or comprise) a tracking area update procedure.

The procedure (e.g., the NAS procedure) may be (or comprise) a PDN connectivity procedure. The procedure (e.g., the NAS procedure) may be (or comprise) a PDN disconnect procedure.

The procedure (e.g., the NAS procedure) may be (or comprise) a bearer resource allocation procedure. The procedure (e.g., the NAS procedure) may be (or comprise) a bearer resource modification procedure.

The procedure (e.g., the first procedure, the second procedure, the third procedure) may be (or comprise) an RRC procedure.

The procedure (e.g., the RRC procedure) may be (or comprise) an RRC connection establishment procedure.

The procedure (e.g., the RRC procedure) may be (or comprise) an RRC connection re-establishment procedure.

The procedure (e.g., the RRC procedure) may be (or comprise) an RRC connection resume procedure.

The procedure (e.g., the RRC procedure) may be (or comprise) a UL information transfer procedure.

The procedure (e.g., the RRC procedure) may be (or comprise) a UE assistance information procedure.

The procedure (e.g., the RRC procedure) may be (or comprise) a UL message segment transfer procedure.

Exemplary embodiments of the present invention are described below.

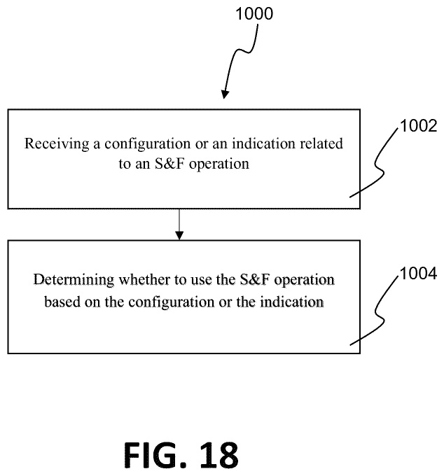

Referring to FIG. 18, with this and other concepts, systems, and methods of the present invention, a method 1000 of a UE comprises receiving a configuration or an indication related to an S&F operation (step 1002), and determining whether to use the S&F operation based on the configuration or the indication (step 1004).

In various embodiments, the indication is an S&F mode indication.

In various embodiments, the configuration is a UE type configuration.

In various embodiments, the configuration is a traffic type configuration.

In various embodiments, the configuration is a QoS parameter.

In various embodiments, if the UE determines to use the S&F operation, the UE performs a procedure or transmission based on the S&F operation.

In various embodiments, if the UE determines not to use the S&F operation, the UE performs a procedure or transmission not based on the S&F operation.

Referring back to FIGS. 3 and 4, in one or more embodiments from the perspective of a UE, the device 300 includes a program code 312 stored in memory 310 of the transmitter. The CPU 308 could execute program code 312 to: (i) receive a configuration or an indication related to an S&F operation; and (ii) determine whether to use the S&F operation based on the configuration or the indication. Moreover, the CPU 308 can execute the program code 312 to perform all of the described actions, steps, and methods described above, below, or otherwise herein.

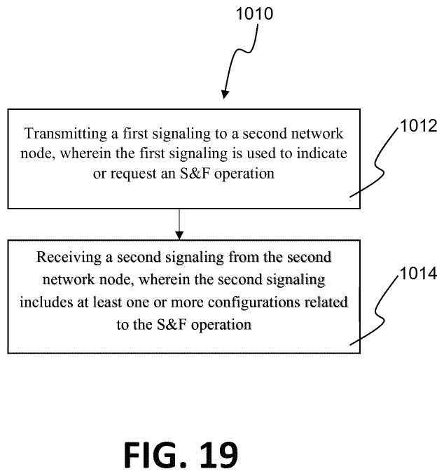

Referring to FIG. 19, with this and other concepts, systems, and methods of the present invention, a method 1010 of a first network node comprises transmitting a first signaling to a second network node, wherein the first signaling is used to indicate or request an S&F operation (step 1012), and receiving a second signaling from the second network node, wherein the second signaling includes at least one or more configurations related to the S&F operation (step 1014).

In various embodiments, the first network node is located in a satellite.

In various embodiments, the first network node is an NG-RAN node.

In various embodiments, the second network node is located on the ground.

In various embodiments, the second network node is a 5G CN node.

In various embodiments, second signaling is in response to the first signaling.

In various embodiments, the method further comprises transmitting a third signaling to the second network node, wherein the third signaling is transmitted in response to receiving the second signaling.

Referring back to FIGS. 3 and 4, in one or more embodiments from the perspective of first network node, the device 300 includes a program code 312 stored in memory 310 of the transmitter. The CPU 308 could execute program code 312 to: (i) transmit a first signaling to a second network node, wherein the first signaling is used to indicate or request an S&F operation; and (ii) receive a second signaling from the second network node, wherein the second signaling includes at least one or more configurations related to the S&F operation. Moreover, the CPU 308 can execute the program code 312 to perform all of the described actions, steps, and methods described above, below, or otherwise herein.

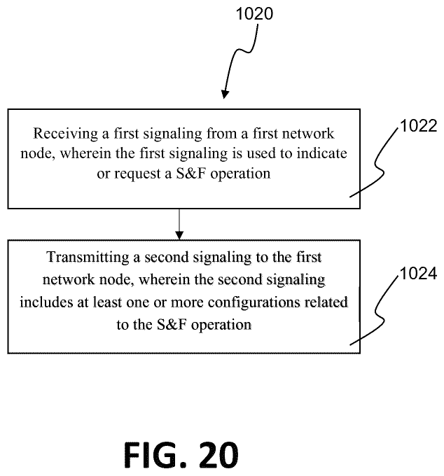

Referring to FIG. 20, with this and other concepts, systems, and methods of the present invention, a method 1020 of a second network node, comprises receiving a first signaling from a first network node, wherein the first signaling is used to indicate or request a S&F operation (step 1022), and transmitting a second signaling to the first network node, wherein the second signaling includes at least one or more configurations related to the S&F operation (step 1024).

In various embodiments, the first network node is located in a satellite.

In various embodiments, the first network node is an NG-RAN node.

In various embodiments, the second network node is located on the ground.

In various embodiments, the second network node is a 5G CN node.

In various embodiments, the second signaling is in response to the first signaling.

In various embodiments, the method further comprises transmitting a third signaling to the second network node, wherein the third signaling is transmitted in response to receiving the second signaling.

Referring back to FIGS. 3 and 4, in one or more embodiments from the perspective of second network node, the device 300 includes a program code 312 stored in memory 310 of the transmitter. The CPU 308 could execute program code 312 to: (i) receive a first signaling from a first network node, wherein the first signaling is used to indicate or request a S&F operation; and (ii) transmit a second signaling to the first network node, wherein the second signaling includes at least one or more configurations related to the S&F operation. Moreover, the CPU 308 can execute the program code 312 to perform all of the described actions, steps, and methods described above, below, or otherwise herein.

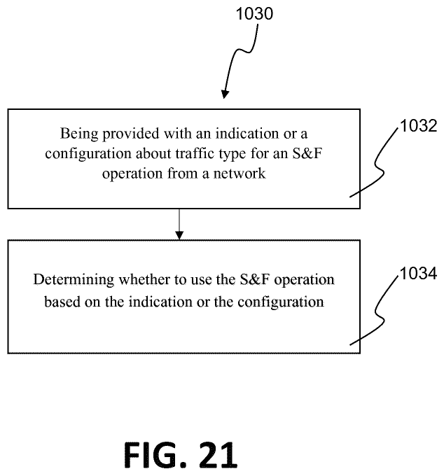

Referring to FIG. 21, with this and other concepts, systems, and methods of the present invention, a method 1030 of UE comprises being provided with an indication or a configuration about traffic type for an S&F operation from a network (step 1032), and determining whether to use the S&F operation based on the indication or the configuration (step 1034).

In various embodiments, the S&F operation provides communication service when a feeder link of the network is not available.

In various embodiments, the feeder link is a connection between a satellite network and a ground network.

In various embodiments, the UE considers that the S&F operation is allowed for a first traffic if the first traffic fulfils a condition of the indication or the configuration.

In various embodiments, the UE determines to perform a transmission or initiate a procedure using the S&F operation for the first traffic if the UE considers the S&F operation allowed for the first traffic.

In various embodiments, the UE considers that the S&F operation is not allowed for a second traffic if the second traffic does not fulfil a condition of the indication or the configuration.

In various embodiments, the UE determines to not perform a transmission or not initiate a procedure using the S&F operation for the second traffic if the UE considers the S&F operation not allowed for the second traffic.

In various embodiments, the configuration is pre-configured.

In various embodiments, the indication or the configuration is included in system information or a NAS message.

In various embodiments, the indication or the configuration is included in a response message to a UE request or during a registration procedure.

Referring back to FIGS. 3 and 4, in one or more embodiments from the perspective of UE, the device 300 includes a program code 312 stored in memory 310 of the transmitter. The CPU 308 could execute program code 312 to: (i) be provided with an indication or a configuration about traffic type for an S&F operation from a network; and (ii) determine whether to use the S&F operation based on the indication or the configuration. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations. uses or adaptation of the invention following. in general. the principles of the invention. and including such departures from the present disclosure as come within the known and customary practice within the art to which the invention pertains.

What is claimed is:

1. A method for a User Equipment (UE), comprising:
being provided with an indication or a configuration about traffic type for a store and forward (S&F) operation from a network; and
determining whether to use the S&F operation based on the indication or the configuration.

2. The method of claim 1, wherein the S&F operation provides communication service when a feeder link of the network is not available.

3. The method of claim 2, wherein the feeder link is a connection between a satellite network and a ground network.

4. The method of claim 1, wherein the UE considers that the S&F operation is allowed for a first traffic if the first traffic fulfils a condition of the indication or the configuration.

5. The method of claim 4, wherein the UE determines to perform a transmission or initiate a procedure using the S&F operation for the first traffic if the UE considers the S&F operation allowed for the first traffic.

6. The method of claim 1, wherein the UE considers that the S&F operation is not allowed for a second traffic if the second traffic does not fulfil a condition of the indication or the configuration.

7. The method of claim 6, wherein the UE determines to not perform a transmission or not initiate a procedure using the S&F operation for the second traffic if the UE considers the S&F operation not allowed for the second traffic.

8. The method of claim 1, wherein the configuration is pre-configured.

9. The method of claim 1, wherein the indication or the configuration is included in system information or a Non-Access Stratum (NAS) message.

10. The method of claim 1, wherein the indication or the configuration is included in a response message to a UE request or during a registration procedure.

11. A User Equipment (UE), comprising:
a memory; and
a processor operatively coupled with the memory, wherein the processor is configured to execute a program code to:
be provided with an indication or a configuration about traffic type for a store and forward (S&F) operation from a network; and
determine whether to use the S&F operation based on the indication or the configuration.

12. The UE of claim 11, wherein the S&F operation provides communication service when a feeder link of the network is not available.

13. The UE of claim 12, wherein the feeder link is a connection between a satellite network and a ground network.

14. The UE of claim 11, wherein the UE considers that the S&F operation is allowed for a first traffic if the first traffic fulfils a condition of the indication or the configuration.

15. The UE of claim 14, wherein the UE determines to perform a transmission or initiate a procedure using the S&F operation for the first traffic if the UE considers the S&F operation allowed for the first traffic.

16. The UE of claim 11, wherein the UE considers that the S&F operation is not allowed for a second traffic if the second traffic does not fulfil a condition of the indication or the configuration.

17. The UE of claim 16, wherein the UE determines to not perform a transmission or not initiate a procedure using the S&F operation for the second traffic if the UE considers the S&F operation not allowed for the second traffic.

18. The UE of claim 11, wherein the configuration is pre-configured.

19. The UE of claim 11, wherein the indication or the configuration is included in system information or a Non-Access Stratum (NAS) message.

20. The UE of claim 11. wherein the indication or the configuration is included in a response message to a UE request or during a registration procedure.
